(19) United States
(12) Patent Application Publication
(10) Pub. No.: US 2003/0112731 A1
(43) Pub. Date: Jun. 19, 2003

(54) Phase-change recording medium, recording method and recorder therefor

(76) Inventor: Shuichi Ohkubo, Tokyo (JP)

Correspondence Address: KATTEN MUCHIN ZAVIS ROSENMAN, 575 MADISON AVENUE, NEW YORK, NY, 10022-2585, US

(21) Appl. No.: 10/238,764

(22) Filed: Sep. 10, 2002

(30) Foreign Application Priority Data
Sep. 13, 2001 (JP) 277874/2001
Mar. 27, 2002 (JP) 88194/2002

(51) Int. Cl. G11B 7/24

(52) U.S. Cl. 369/59.11; 369/275.2; 369/283

(57) ABSTRACT

A phase-change recording medium of the present invention includes a reflection layer, a first protective layer, a phase-change recording layer which changes in phase between a crystallization state and an amorphous state by irradiation of a laser beam, and a second protective layer. The phase-change recording layer contains a component expressed by M_{z}Si_{y}(SbₓTe₁₋ₓ)_{1-y-z} (where 0.65≦x≦0.8, 0.1≦y+z≦0.2, M represents Ge, AgIn, AuIn, or AgAuIn) as a main component. Further, in the phase-change recording medium of the present invention, an absorptivity Ac of the phase-change recording layer in the crystallization state is set higher than an absorptivity Aa of the phase-change recording layer in the amorphous state.

### BACKGROUND OF THE INVENTION

The present invention relates to a phase-change recording medium for recording and reproducing information by irradiating a laser beam, a recording method and a recorder therefor. The present invention particularly concerns a phase-change recording medium for recording and reproducing optical information by changing a reflectance or an optical phase of a recording layer by irradiating a laser beam, and a method of recording optical information, the method using the phase-change recording medium.

The phase-change recording medium is a kind of a rewritable optical disk, which records optical information by changing a reflectance or an optical phase of the phase-change recording medium by irradiating a laser beam. Particularly on the phase-change recording medium, the intensity of a laser beam is changed to record, reproduce, and erase information, so that over-writing using one beam can be performed.

In recent years, as to phase-change recording mediums (hereinafter, referred to as “disks” when necessary), improvement in transfer rate of information has been demanded in order to expand a range of uses, for example, for uses such as recording an HDTV (High Definition Television) broadcast and high-speed archiving. For improvement in transfer rate, it is effective to record, erase, and reproduce information while rotating a disk at high speed.

However, in the case where the disk increases in rotational speed, the time that a laser beam crosses a point on the disk (irradiating time on a point) is shortened. Thus, crystallization on a recording layer (generally corresponding to an erasing operation) becomes insufficient, resulting in deterioration of an over-writing characteristic. Consequently, an erasing rate is reduced and jitter is increased. For example, in the case where a rotational linear velocity is 10 m/s, 100 ns is required as the time that a laser beam with a beam diameter of 1 μm crosses a point of a disk. Further, in the case where a rotational linear velocity is 20 m/s, the time is 50 ns. In general, about 100 ns is required for crystallizing (generally corresponding to an erasing operation) a recording layer used in the phase-change recording mediums. Hence, it is difficult to perform over-writing at high linear velocity on the phase-change recording medium. Consequently, in the case of the phase-change recording medium, it has been difficult to improve a transfer rate of information recorded in the medium.

Further, in order to increase a recording density of a recording medium, it is necessary to reduce a beam diameter of a laser beam used for recording, erasing, and reproducing information. However, when a beam diameter is smaller, the time is shortened that a laser beam crosses a point on a disk. Consequently, the same influence is exerted as an increased rotational speed of the disk, resulting in insufficient crystallization on a recording layer.

In recent years, for higher density, the following method has been proposed: a numeral aperture NA of an objective lens on an optical head is increased to 0.7 or more, a beam diameter is reduced, and a laser beam is irradiated from a surface of a disk to record and reproduce information. However, in such a recording method, in order to increase a rotational speed of the disk to improve a transfer rate, it is necessary to provide a recording layer much higher in crystallization rate than the conventional art (the time of crystallization is short).

As a recording layer with high crystallization rate, a recording layer has been recently proposed, in which Sb is added to a Sb₇Te₃ eutectic composition (for example, SPIE Vol. 4090(2000) pp.135-143). In the composition of the recording layer described in the above document, a eutectic composition is fundamental and Sb is added to the composition. Since Sb is added thus, the time for crystallizing a recording layer can be shortened. However, when Sb is added excessively, the crystallization temperature decreases. Thus, a recorded amorphous mark is more likely to be crystallized. Namely, stability of storing recorded data becomes lower.

Meanwhile, in order to improve the transfer rate of information, CAV (Constant Angular Velocity) is more desirable than CLV (Constant Linear Velocity). This is because CAV can more shorten the waiting time for controlling a rotational speed of a disk. However, for the phase-change recording mediums, CLV having constant linear velocity is generally adopted instead of CAV having constant angular velocity of rotation. One major reason is that in the case of a large diameter of a disk, since CAV largely differs in linear velocity of the disk between the inner circumference and the outer circumference, on the phase-change recording mediums, crystallization becomes insufficient on the outer circumference having high linear velocity. For example, when a recording region ranges from 23 to 58 mm in radius of a disk having a diameter of 120 mm, the linear velocity of the outer circumference is about 2.5 times that of the inner circumference in CAV. When the disk has a small diameter, a difference in linear velocity between the inner circumference and the outer circumference is smaller. However, in order to obtain a recording capacity, the disk needs to have a diameter of about 120 mm. Thus, on the generally used phase-change recording mediums, erasing becomes insufficient (insufficient crystallization) on the outer circumference. Conversely, in the case of a recording medium having a recording layer with high crystallization rate, which can sufficiently crystallize the outer circumference, the inner circumference having low linear velocity does not become amorphous but is more likely to be crystallized after the recording layer is fused. Hence, preferable recording may not be performed on such a medium. In this case, it is considered that a pulse width is shortened so as to increase a cooling speed of recording on the inner circumference when recording is performed using multipath. However, in this case as well, a problem of a complicated recording circuit arises.

### SUMMARY OF THE INVENTION

The present invention has as its object the provision of a phase-change recording medium which has high erasing speed, excellent over-writing characteristics, and high stability of recorded data. Further, another object of the present invention is to provide a phase-change recording medium which can preferably rewrite information by CAV while obtaining a sufficiently large disk diameter and a sufficient recording capacity. Moreover, still another object of the present invention is to provide a recording method and a recorder that have high transfer rate of information.

An aspect of the present invention is a phase-change recording medium for recording and reproducing information by irradiating a laser beam, comprising a reflection layer, a first protective layer, a phase-change recording layer which changes in phase between a crystallization state and an amorphous state by irradiation of a laser beam, and a second protective layer, wherein the phase-change recording layer contains a component expressed by M_{z}Si_{y}(SbₓTe₁₋ₓ)_{1-y-z} (which 0.65≦x≦0.8, 0.1≦y+z≦0.2, M represents Ge, AgIn, AuIn, or AgAuIn) as a main component.

Further, in the aspect of the present invention, it is preferable that an absorptivity Ac of the phase-change recording layer in the crystallization state is higher than an absorptivity Aa of the phase-change recording layer in the amorphous state.

Moreover, another aspect of the present invention is a phase-change recording medium for recording and reproducing information by irradiating a laser beam, comprising a reflection layer, a first protective layer, a phase-change recording layer which changes in phase between a crystallization state and an amorphous state by irradiation of a laser beam, and a second protective layer, wherein the phase-change recording layer contains a component expressed by Ge_{y}(SbₓTe₁₋ₓ)_{1-y} (where 0.02≦y≦0.15, 0.65≦x≦0.84) as a main component, and an absorptivity Ac of the phase-change recording layer in the crystallization state is higher than an absorptivity Aa of the phase-change recording layer in the amorphous state.

### BRIEF DESCRIPTION OF THE DRAWINGS

This above-mentioned and other objects, features and advantages of this invention will become more apparent by reference to the following detailed description of the invention taken in conjunction with the accompanying drawings, wherein:

FIG. 1 is a sectional view showing one embodiment of a phase-change recording medium according to the present invention;

FIG. 2 is a sectional view showing another embodiment of the phase-change recording medium according to the present invention;

FIG. 3 is a diagram showing temperature dependence of a transmittance change of a recording layer in the phase-change recording medium of the present invention;

FIG. 4 is a diagram showing erasing characteristics of the phase-change recording medium according to the present invention;

FIG. 5 is a diagram showing-repetitive reproduction characteristics of the phase-change recording medium according to the present invention;

FIG. 6 is a diagram showing repetitive reproduction characteristics of a conventional phase-change recording medium;

FIG. 7 is a diagram showing an example of a recording strategy;

FIG. 8 is a diagram showing the relationship between jitter and linear velocity during recording using the phase-change recording medium of the present invention;

FIG. 9 is a sectional view showing still another embodiment of the phase-change recording medium according to the present invention; and

FIG. 10 is a diagram showing the relationship between jitter and linear velocity during recording using the phase-change recording medium of the present invention.

### DESCRIPTION OF THE PREFERRED EMBODIMENTS

After through study, the inventor found that the time for crystallization can be shortened without deteriorating stability of an amorphous mark recorded on a phase-change recording medium by adding a specific quantity of “Ge and Si,” “Ag, In, and Si,” or “Au, In, and Si” to a eutectic composition of Sb₇Te₃.

A phase-change recording medium according to Embodiment 1 of the present invention has a recording layer containing GeSbTeSi as a main component. In a composition in which a specific quantity of Si is added to a eutectic composition of SbTe, formation of a crystal nucleus is stimulated as compared with the case where Sb is added excessively. Thus, the recording layer having such a composition can speed up crystallization without lowering a crystallization temperature. Further, when a specific quantity of Ge is added to the composition in addition to Si, it is possible to further improve stability of storing a recorded amorphous mark.

A phase-change recording medium according to Embodiment 2 of the present invention has a recording layer containing XInSiSbTe (where X represents at least one of Ag and Au) as a main component. In the composition in which a specific amount of Si is added to a eutectic composition of SbTe, formation of a crystalline nucleus is stimulated as compared with the case where Sb is added excessively. Hence, the recording layer having such a composition makes it possible to speed up crystallization without lowering a crystallization temperature. Moreover, in addition to Si, specific quantities of In and X are added to the composition, thereby further improving stability of storing an amorphous mark. Besides, an at ratio (atomic ratio: X/In) of In and X is preferable at 0.5 to 1.5 and more preferable at 0.8 to 1.2. Here, it is considered that addition of In improves a recording characteristic and addition of X improves storing stability.

As to the recording layer, the composition of a main component is expressed as M_{z}Si_{y}(SbₓTe₁₋ₓ)_{1-y-z} (where M represents Ge, AgIn, AuIn, or AgAuIn). The ranges of x, y, and z are preferably set at 0.65≦x≦0.8, 0.02≦y≦0.15 (0.1≦y+z≦0.2).

Further, a phase-change recording medium according to Embodiment 3 of the present invention has a recording layer containing Ge_{y} (SbₓTe₁₋ₓ)_{1-y} as a main component. The ranges of x and y are preferably set at 0.6≦x≦0.84, 0.02≦y≦0.15. Moreover, as will be discussed later, in the case of the above composition, the effect of the present invention can be attained by setting an absorptivity Ac of the phase-change recording layer in a crystallization state higher than an absorptivity Aa of the recording layer in an amorphous state.

Besides, in Embodiments 1 to 3, a content of the main component of the recording layer is preferable at 80 at % or more and more preferable at 90 at % or more. Components other than the main component include Al, Cu, Ti, Cr, Mg, Pb, Sn, N, O, and C.

Additionally, a thickness of the recording layer is preferable at 1 to 40 nm and more preferable at 5 to 30 nm. When the recording layer is too thin, it is hard to obtain an unifom layer and a desired film characteristic cannot be achieved. Meanwhile, when the recording layer is too thick, extremely high recording power is required during recording, thereby increasing thermal interference during recording. Hence, preferable recording may not be performed.

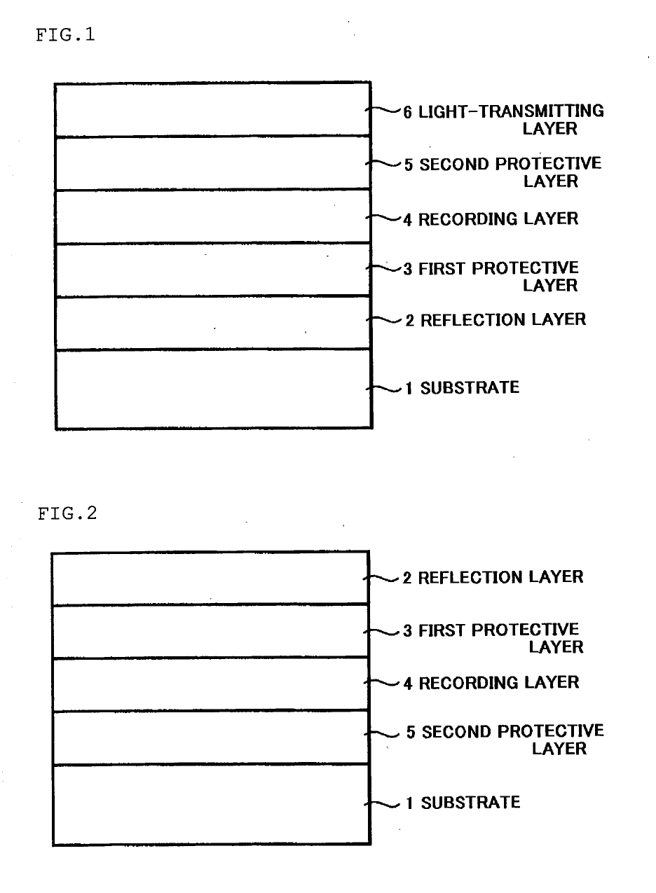

FIG. 1 is a sectional view showing a phase-change recording layer having the above-described recording layer according to an embodiment of the present invention. As shown in FIG. 1, the phase-change recording medium of the present invention has a laminated structure in which a reflection layer 2, a first protective layer 3, a recording layer 4, a second protective layer 5, and light-transmitting layer 6 are formed in this order on a supporting substrate 1. On the phase-change recording medium configured thus, information can be recorded and reproduced by irradiating a laser beam from the side of the light-transmitting layer 6.

FIG. 2 shows a phase-change recording medium of the present invention that is an embodiment different from that of FIG. 1. As shown in FIG. 2, the phase-change recording medium of the present invention has a laminated structure in which a second protective layer 5, a recording layer 4, a first protective layer 3, and a reflection layer 2 are formed in this order on a supporting substrate 1. On the phase-change recording medium configured thus, information can be recorded and reproduced by irradiating a laser beam from the side of the supporting substrate 1.

Additionally, for higher density, the configuration of FIG. 1, in which a laser beam is irradiated from the side of the light-transmitting layer 6 is more preferable than that of FIG. 2. This is because the configuration of FIG. 1 can more easily obtain a wide tilt margin (suppress degradation in characteristic when a disk is tilted) even when a numerical aperture (NA) is increased from 0.7 to 0.85.

As the reflection layer 2, a material having main components including Ag, Al, Au, Cu, and Ni is preferably used. Further, in order to add a desired characteristic, it is also preferable to use a material in which specific quantities of Ti, Cr, Pd, Si, and so on are added. Further, for example, it is desirable that the reflection layer be 50 to 500 nm in thickness. When the reflection layer is too thin, desired reflectivity cannot be obtained, and when the reflection layer is too thick, a problem such as low productivity and a crack is more likely to arise.

As the first protective layer 3 and the second protective layer 5, it is preferable to use dielectrics made of ZnS-SiO₂, Al₂O₃, SiO₂, Ta₂O₅, SiN, AlN, and so on. Moreover, the first and second protective layers may use these dielectrics as single layers, or if necessary, these dielectrics may be used as a multilayer configuration having a plurality of dielectrics alternately deposited. It is preferable that the first protective layer provided between the recording layer and the reflection layer is 10 to 50 nm in thickness. When the first protective layer is too thin, a desired film characteristic cannot be obtained, and when the first protective layer is too thick, the cooling effect, that is heat conduction from the recording layer to the reflection layer, is degraded. It is preferable that the second protective layer provided on the laser emitting side of the recording layer is 50 to 500 nm in thickness. When the second protective layer is too thin, desired film characteristics such as intensity and optical characteristics cannot be obtained, and when the second protective layer is too thick, a problem such as low productivity and a crack is more likely to arise. Besides, as will be discussed later, as to light with a wavelength of about 400 nm, it is preferable that the first protective layer is 20 to 40 nm in thickness and the second protective layer is 70 to 110 nm in thickness. With such setting, Rc<Ra can be readily realized in a four-layer structure in which the reflection layer, the first protective layer, the recording layer, and the second protective layer are laminated in this order. Rc represents a reflectivity of the recording medium when the recording layer is in a crystallization state. Further, Ra represents a reflectivity of the recording medium when the recording layer is in an amorphous state.

As the supporting substrate, it is possible to use a material including plastic such as polycarbonate and polymethyl methacrylate and glass.

The light-transmitting layer 6 can be formed by using a transparent sheet such as a glass sheet and a polycarbonate sheet and a transparent resin layer made of an ultraviolet-curing resin and so on. The transparent sheet can be provided after being bonded by, for example, transparent resin made of an ultraviolet-curing resin.

In the case of the phase-change recording medium of the present invention, information can be preferably rewritten even when the medium has a short beam irradiating time of 40 ns or less. For example, even in the case of a recording condition with irradiating time of 15 to 40 ns, information can be preferably rewritten.

Moreover, in the case of the phase-change recording medium of the present invention, even when a laser beam irradiated on the medium has a small beam diameter of 0.5 μm or less, or 0.4 μm or less, information can be preferably rewritten. It is preferable that light irradiated on the medium has a beam diameter of 0.3to 0.5 μm. Hence, it is possible to provide the phase-change recording medium which can perform high-density recording and can preferably rewrite information.

Moreover, in the case of the phase-change recording medium, even when the medium has a large size (diameter), information can be preferably rewritten. For example, even when the disk diameter (diameter) is 100 mm or more, or 120 mm or more, information can be preferably rewritten. Besides, a recording region on the disk can be 20 mm to (outermost radius −2) mm in radius.

Further, in the case of the phase-change recording medium of the present invention, it is preferable that an absorptivity Ac of the phase-change recording layer in a crystallization state is higher than an absorptivity Aa of the phase-change recording layer in an amorphous state. Setting Ac higher than Aa is effective for suppressing increased jitter. AgInSbTe, Sb₇Te₃+Ge, and so on have been known as a representative example of a material making up a eutectic phase-change recording layer used for conventional CD-RW and DVD-RW. As to these materials, Aa is set higher than Ac. Further, in the case of the recording medium in which Aa is thus set higher than Ac, when the rotational linear velocity is increased (for example, to 3600 rpm or more), fitter may increase. The increased jitter can be suppressed by adjusting the materials and composition of the recording layer to increase a crystallization rate. However, when the crystallization rate of the recording layer is excessively increased, stability of storing a recording mark is generally degraded. The recording mark is recorded on the recording layer. Moreover, in the case of an operation using CAV, on the recording medium having such a recording layer, recording may not be accurately performed on the inner circumference having low linear velocity.

As described above, in order to suppress increased jitter during over-writing, it is not preferable that control is exercised only by increasing the crystallization rate of the recording layer.

In order to achieve preferable over-writing with high linear velocity while suppressing increased jitter, it is preferable to use the phase-change recording medium comprising the recording layer having the composition of the present invention to set Ac higher than Aa. As the recording layer of the present invention, as described above, the phase-change recording medium preferably uses the recording layer which has the composition containing Si. However, even in the case of Embodiment 3 not containing Si in the recording layer, jitter can be suppressed and preferable over-writing can be achieved with high linear velocity by setting Ac higher than Aa.

Additionally, in order to set Ac higher than Aa, it is effective to set a reflectivity Ra of the phase-change recording layer higher than a reflectivity Rc of the phase-change recording medium. The reflectivity Ra is obtained when the phase-change recording layer is in an amorphous state, and the reflectivity Rc is obtained when the phase-change recording layer is in a crystallization state.

When light irradiated to the recording medium has a wavelength of 400 nm and the recording medium has a four-layer structure in which the reflection layer, the first protective layer, the recording layer, and the second protective layer are laminated in this order, Rc<Ra can be readily realized by setting the thickness of the first protective layer at 20 to 40 nm and the thickness of the second protective layer at 70 to 110 nm. Here, the second protective layer may have a multilayer configuration having dielectric layers with different indexes of refraction.

As described above, in order to obtain Ac>Aa, it is preferable to set the layer structure so as to have Rc<Ra. However, even in the case of Rc>Ra, Ac>Aa can be realized by providing a light-absorbing layer between the first protective layer and the reflection layer. As the light-absorbing layer, it is desirable to provide a layer which absorbs light with a wavelength of 380 to 420 nm. The light is a laser beam suitable for high density. The thickness of the light-absorbing layer is desirable at 3 to 20 nm. When the light-absorbing layer is too thin, it is difficult to form a film of fine quality, and when the light-absorbing layer is too thick, light transmitted through the light-absorbing layer is considerably reduced, so that the relationship of Ac>Aa is not satisfied. As a main component of the light-absorbing layer, it is preferable to use at least a material selected from Ti, Ni, Cu, Au, Ag, oxide thereof, and nitride thereof. The content of the main component is preferable at 80 at % or more, and more preferable at 90 at % or more. As components other than the main component, dielectrics made of SiO₂, SiN, Ta₂O₅, and so on, N, O and the like are available.

With the recording medium having the above configuration, during recording in which the disk has a constant rotational angular velocity and the same recording strategy, recording can be performed while suppressing increased jitter.

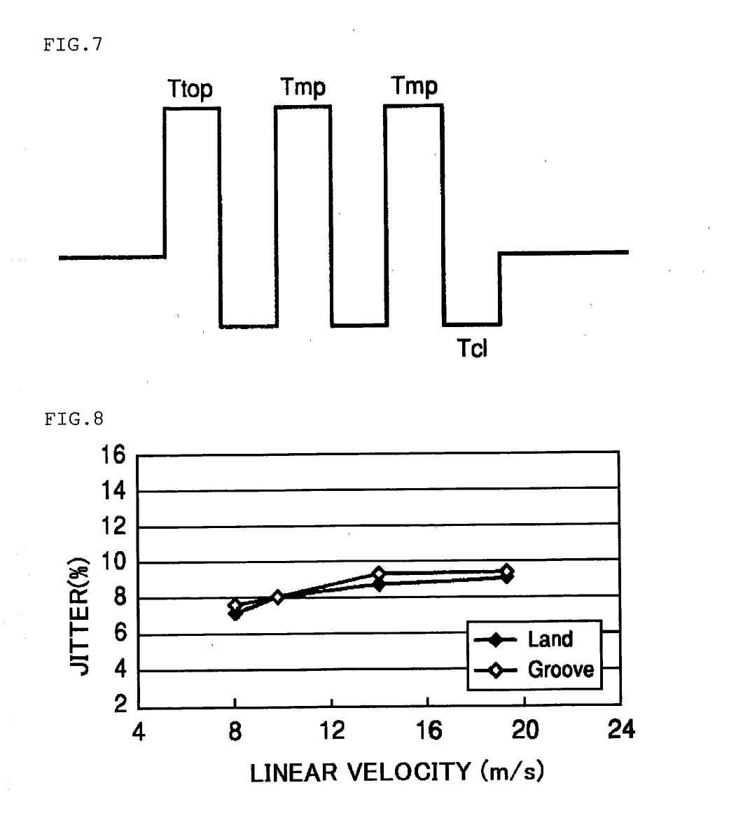

Further, as a method for suppressing increased jitter, it is also effective to change a cooling pulse width (corresponding to an end part of a recording pulse, Tcl of FIG. 7) of the recording strategy according to a position of the recording medium. To be specific, the cooling pulse width is smaller along the inner circumference to the outer circumference, so that increased jitter can be suppressed.

As a recorder used for recording and reproducing on the phase-change recording medium of the present invention, for example, a device is available having a laser light source, an optical head equipped with an objective lens, a drive for moving a position of irradiating a laser beam to a prescribed position, a variety of control units for controlling the tracking direction and position and focusing of a laser beam, a control unit of laser power, and a rotation controller of the recording medium.

### EXAMPLES

Hereinafter, examples of the present invention will be discussed in detail.

### Example 1

As a phase-change recording medium of the present invention, a recording medium of FIG. 1 was configured. In FIG. 1, the recording medium was formed with a layer structure in which an Al-3 at%Ti layer with a thickness of 100 nm was formed as a reflection layer 2, an Al₂O₃ layer with a thickness of 25 nm was formed as a first protective layer 3, a Ge_{z}Si_{y}(Sb_{0.75}Te_{0.25})_{1-y-z} layer with a thickness of 15 nm was formed as a recording layer 4, a ZnS—SiO₂ layer with a thickness of 90 nm was formed as a second protective layer 5, and an ultraviolet-curing resin layer with a thickness of 0.1 mm was formed as a light-transmitting layer 6 in this order on a polycarbonate substrate 1 having a thickness of 1.1 mm. The medium was circular with a diameter of 120 mm and formed a recording region of 23 to 58 mm in the radius direction from the center of the circle.

Eight patterns of the recording medium were prepared with variations of a composition (y, z) of the recording layer. Subsequently, over-writing characteristics and crystallization temperatures of the prepared recording mediums were measured.

Crystallization temperatures were measured as follows: as a sample, a ZnS—SiO₂ protective layer, a recording layer, and a ZnS—SiO₂ protective layer were laminated in this order on a glass substrate. At this moment, eight patterns of the recording layer were prepared with variations of y, z. And then, a change in transmittance relative to a change in temperature (<Tr/<T) was examined while the sample was heated. <Tr represents a change in transmittance (%) and <T represents a change in temperature (deg). The measurements were made with <T=1 deg.

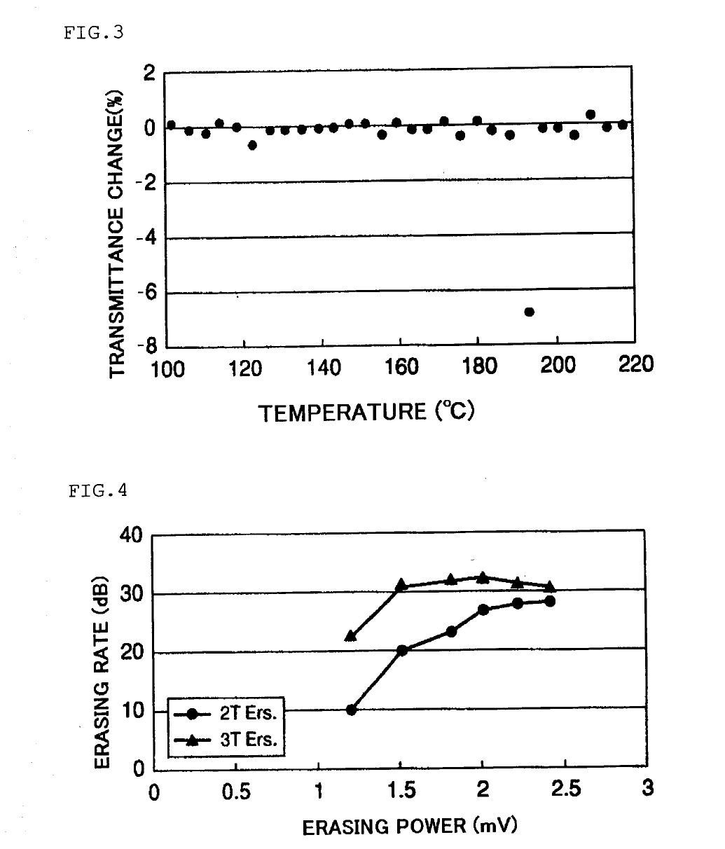

FIG. 3 is an example showing the results. The used recording layer has y of 0.05 and z of 0.09. The vertical axis of FIG. 3 indicates a rate of change (%) in transmittance. As shown in FIG. 3, a transmittance is changed at 190° C. It is considered that a transmittance is changed with crystallization. In the present example, the temperature is referred to as a crystallization temperature. Besides, in the present specification, the crystallization temperature is defined as a temperature at which the transmittance changes most rapidly. The following results of the crystallization temperature were all measured by the above method.

Further, over-writing characteristics were measured as follows: a linear velocity for over-writing was set at 22 m/s, an optical head with a wavelength of 405 nm and NA=0.85 was used, recording power was set at 5.2 mW, reproducing power was set at 0.3 mW, and light irradiated on the recording medium had a beam diameter of 0.4 μm (in the radius direction and the orthogonal direction of the disk).

Moreover, in order to examine the influence of over-writing, recording frequencies of 40 MHz (2T signal) and 26.7 MHz (3T signal) were overwritten with each other, and erasabilities of the frequencies were examined.

FIG. 4 shows the relationship between erasability and erasing power of a recording layer having a recording layer with a composition of z=0.09 and y=0.05. As shown in FIG. 4, it is found that both of the 2T signal and the 3T signal have high erasability of 26 dB or more at erasing power of 2 mW or more.

Further, under the same conditions, erasabilities were examined for the recording mediums which were prepared with variations of the composition (y, z). As shown in FIG. 4, values where both of the 2T signal and the 3T were substantially constant were used as erasabilities of the recording mediums.

Table 1 shows the relationship between crystallization temperatures and erasabilities of the recording mediums. The erasabilities were measured by the above-described method. As shown in Table 1, when y+z ranges from 0.1 to 0.2, high erasability of 26 dB or more and high crystallization temperature are compatible. Additionally, low crystallization temperature suggests low stability of storing recording marks. Moreover, in the present example, GeSiSbTe was used as a recording layer. Even when AgIn, AuIn, or AgAuIn is used instead of Ge, the same effect can be obtained.

TABLE 1
Relationship between recording layer composition and
erasability and crystallization temperature

| | | | Erasability | Crystallization |
|---|---|---|---|---|
| y | z | y + z | (dB) | temperature (°) |
| 0.04 | 0.04 | 0.08 | 35 | 150 |
| 0.04 | 0.06 | 0.1 | 30 | 180 |
| 0.04 | 0.08 | 0.12 | 28 | 190 |
| 0.04 | 0.16 | 0.2 | 26 | 200 |
| 0.04 | 0.18 | 0.22 | 22 | 220 |
| 0.09 | 0.01 | 0.1 | 33 | 180 |
| 0.09 | 0.05 | 0.14 | 30 | 190 |
| 0.09 | 0.11 | 0.2 | 26 | 200 |

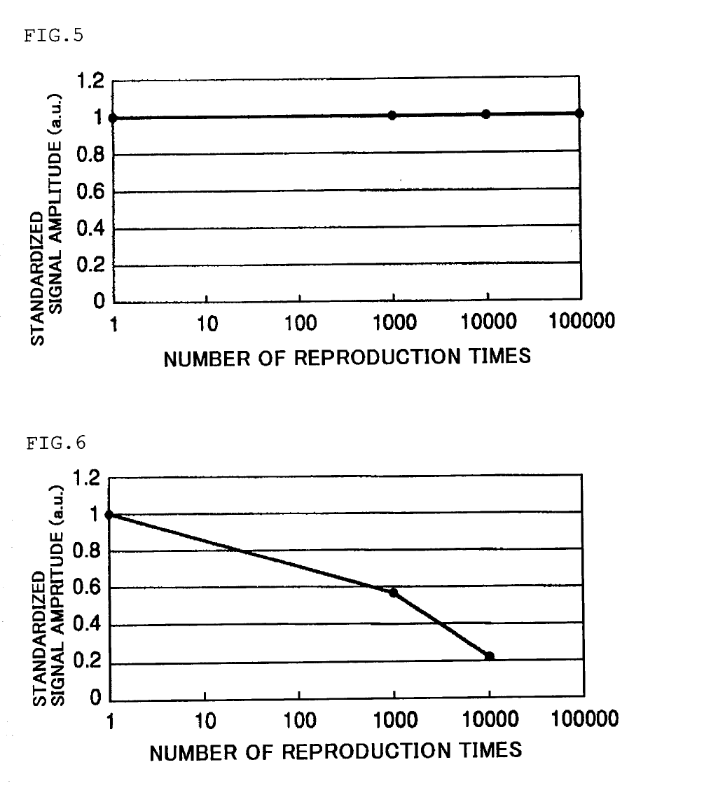

Further, in order to find stability of storing recorded information (recording marks) of the prepared recording medium, the following measurements were made: after the 2T signal was recorded at a linear velocity of 22 m/s, the linear velocity was set at 7 m/s, reproducing power was set at 0.4 mW to repeatedly perform reproducing, and a change in signal amplitude was examined. FIG. 5 shows the results. The recording layer of the used recording medium had a composition of Ge_{0.09}Si_{0.05}(Sb_{0.75}Te_{0.25})_{0.86}. As shown in FIG. 5, even after 100,000 times of reproduction, signal amplitude hardly decreased.

Besides, the same measurements were made on the compositions of Table 1 (compositions satisfying 0. 1≦y+z≦0.2) Similarly, even after 100,000 times of reproduction, signal amplitude hardly changed.

### Comparative Example 1

Next, as a comparative example of the present invention, a recording medium was configured such that a recording layer had a composition of Ge_{0.06}Sb_{0.8}Te_{0.14}. In the present comparative example, in order to improve the crystallization rate of the recording layer, a large quantity of Sb was added in the composition. Thus, the recording layer had a low crystallization temperature of 70° C. Besides, the disk was identical to that of Example 1 in film configuration and so on other than the composition of the recording layer.

A 2T signal was recorded at a linear velocity of 22 m/s by using the disk (the beam diameter was equal to that of Example 1). Thereafter, the linear velocity was set at 7 m/s, reproducing power was set at 0.4 mW to repeatedly perform reproduction, and a change in signal amplitude was examined. FIG. 6 shows the results. As shown in FIG. 6, signal amplitude was considerably degraded as the number of reproduction times increases.

Additionally, the phase-change recording medium of Example 1 and the phase-change recording medium of Comparative Example 1 are substantially equal to each other in absorptivity (about 90%) of the recording layers in an amorphous state. Thus, it is suggested that a difference in repetitive reproduction characteristic between the disks reflects a difference in stability of storing in an amorphous state of the recording layers. From the above results, it is found that Si is added instead of Sb, so that the crystallization rate of the recording layer can be improved without degrading stability of storing information recorded in the recording layer.

### Example 2

As in the case of Example 1, a recording medium having the configuration of FIG. 1 was prepared. Namely, a phase-change recording medium was prepared in which an Al-3at %Ti layer with a thickness of 100 nm was formed as a reflection layer 2, an Al₂O₃ layer with a thickness of 30 nm was formed as a first protective layer 3, a Ge_{y}(SbₓTe₁₋ₓ)-_{y} layer with a thickness of 15 nm was formed as a recording layer 4, a ZnS—SiO₂ layer with a thickness of 90 nm was formed as a second protective layer 5, and an ultraviolet-curing resin layer with a thickness of 0.1 mm was formed as a light-transmitting layer 6 on a polycarbonate substrate 1 with a thickness of 1.1 mm. The recording medium was circular with a diameter of 120 mm and formed a recording region of 23 to 58 mm in the radius direction from the center of the circle.

In the present example, 12 patterns of the recording medium were prepared with variations of the recording layer. Further, the first protective layer and the second protective layer were adjusted in thickness to change optical characteristics (Aa, Ac) of the prepared recording mediums. Jitter of the prepared disks was measured in the conditions discussed below. The disk was rotated at a linear velocity of 10 to 22 m/s. A laser beam emitted to the disk was 405 nm in wavelength. An optical head with NA of 0.85 was used to perform over-writing, and jitter was measured. Jitter was measured after ten times of over-writing. A clock frequency T was changed according to linear velocity such that a recording linear density was fixed at 0.13 μm/bit. A beam diameter was set at 0.4 μm (in the radius direction and orthogonal direction of the disk). Recording was carried out with a recording strategy shown in FIG. 7, in which Ttop was 0.4T, Tmp was 0.4T, and Tcl was 0.5. However, the above-described strategy parameters were not limited to the above.

Table 2 shows jitter values and crystallization temperature of the prepared disks. Jitter values are shown for linear velocities of 10 m/s, 15 m/s, and 22 m/s.

TABLE 2
Relationship between composition of recording layer
and jitter and crystallization temperature

| | | | | Jitter | Jitter | Jitter | Crystallization |
|---|---|---|---|---|---|---|---|
| x | y | Aa | Ac | 10 m/s | 15 m/s | 22 m/s | Temperature |
| 0.6 | 0.1 | 65 | 78 | 11 | 13 | 18 | 210 |
| 0.65 | 0.1 | 68 | 80 | 10 | 11 | 14 | 200 |
| 0.65 | 0.1 | 85 | 70 | 12 | 16 | 20 | 200 |
| 0.75 | 0.1 | 69 | 82 | 9 | 9.5 | 10.5 | 195 |
| 0.75 | 0.1 | 86 | 71 | 10 | 13 | 17 | 195 |
| 0.83 | 0.1 | 68 | 80 | 8 | 8.5 | 9 | 185 |
| 0.87 | 0.1 | 68 | 80 | 7.5 | 7.7 | 8 | 150 |
| 0.87 | 0.1 | 88 | 73 | 8.5 | 9 | 9.5 | 150 |
| 0.84 | 0.01 | 65 | 77 | 8.5 | 8.8 | 9 | 155 |
| 0.84 | 0.03 | 66 | 77 | 9 | 9.5 | 10 | 180 |
| 0.84 | 0.15 | 64 | 76 | 10 | 11 | 13 | 210 |
| 0.84 | 0.18 | 65 | 77 | 12 | 14 | 17 | 220 |

As shown in Table 2, when the phase-change recording layer has the Ge_{y}(SbₓTe₁₋ₓ)_{1-y} composition, the ranges of x and y are 0.65≦x≦0.84 and 0.02≦y≦0.15, and Ac>Aa is satisfied, it is possible to obtain preferable jitter characteristics and high crystallization temperature even at linear velocity of 10 m/s or more. Additionally, stability of storing recorded information is preferable on all of the disks having the recording layers with the above composition.

### Example 3

As in the case of Example 1, a recording medium having the configuration of FIG. 1 was prepared. Namely, a phase-change recording medium was prepared in which an Al-3at%Ti layer with a thickness of 100 nm was formed as a reflection layer 2, a ZnS—SiO₂ layer with a thickness of 35 nm was formed as a first protective layer 3, a Ge_{0.09}Si_{0.05}(Sb_{0.68}Te_{0.32})_{0.86} layer with a thickness of 13 nm was formed as a recording layer 4, a ZnS—SiO₂ layer with a thickness of 85 nm was formed as a second protective layer 5, and an ultraviolet-curing resin layer with a thickness of 0.1 mm was formed as a light-transmitting layer 6 on a polycarbonate substrate 1 with a thickness of 1.1 mm. The recording medium was circular with a diameter of 120 mm and formed a recording region of 23 to 58 mm in the radius direction from the center of the circle. The prepared disk had Rc of 5%, Ra of 25%, Ac of 87%, and Aa of 71%.

The disk was rotated with a constant rotational angular velocity, over-writing was performed using an optical head with a wavelength of 405 nm and NA=0.85, and jitter was measured. Jitter was measured after ten times of over-writing. A measurement region ranged from 23 to 58 mm in radius. A clock frequency T was changed according to radius such that a recording linear density was fixed at 0.13 μm/bit. A beam diameter was set at 0.4 μm (in the radius direction and orthogonal direction of the disk).

Information on the disk was recorded using a recording strategy of FIG. 7. The recording strategy was equal on the inner circumference and the outer circumference of the disk. However, a recording strategy is not limited to the above and may be changed properly.

Besides, for reduction of jitter, it is also effective to change Tcl according to radius. Particularly when only Tcl is adjusted, a device can be realized without high degrees of complexity.

FIG. 8 shows the relationship between linear velocity and jitter. As shown in FIG. 8, jitter is almost equal within a range from a linear velocity of 8 m/s (23 mm in radius) to 20 m/s (58 mm in radius), and jitter is 10% or less.

Additionally, as to the recording medium, stability of storing recorded information (recording marks) was preferable.

### Example 4

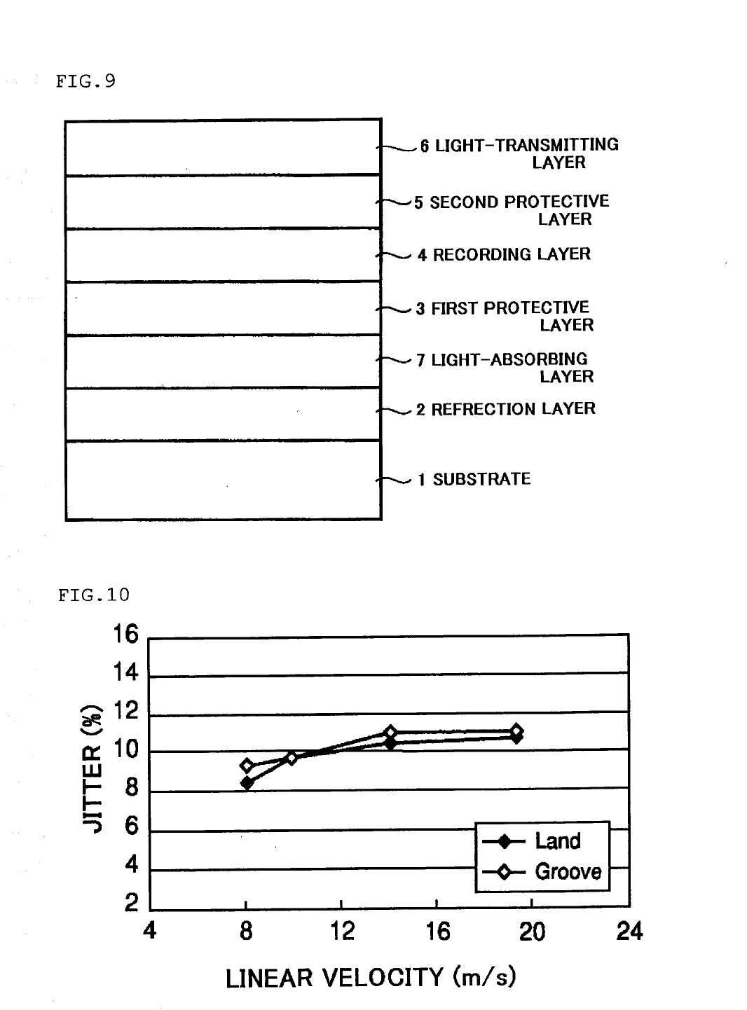

As a phase-change recording medium of the present example, a recording medium of FIG. 9 was configured. In FIG. 9, the phase-change recording medium was prepared in which a layer made of Ag98 at %, Pd1 at %, and Cu1 at % with a thickness of 100 nm was formed as a reflection layer 2, a nitrogen deficiency SiN layer with a thickness of 15 nm was formed as a light-transmitting layer 7, a ZnS—SiO₂ layer with a thickness of 25 nm was formed as a first protective layer 3, a Ge_{0.09}Si_{0.05}(Sb_{0.68}Te_{0.32})_{0.86} layer with a thickness of 13 nm was formed as a recording layer 4, a ZnS—SiO₂ layer with a thickness of 60 nm was formed as a second protective layer 5, and an ultraviolet-curing resin layer with a thickness of 0.1 mm was formed as a light-transmitting layer 6 on a polycarbonate substrate 1 with a thickness of 1.1 mm. The medium was circular with a diameter of 120 mm. Moreover, the medium had a recording region of 23 to 58 mm in the radius direction from the center of the circle. The recording medium had Rc of 13%, Ra of 5%, Ac of 85%, and Aa of 80%.

As in the case of Example 3, jitter was measured. FIG. 10 shows the results. As shown in FIG. 10, jitter values are substantially constant regardless of linear velocity. In the present example, since a difference between Rc and Ra is small and signal amplitude is small, jitter values are somewhat larger than those of Example 3 (FIG. 8).

### Example 5

In order to examine the effects of the additive components to the recording film, we evaluated the read/write characteristics of the phase change media consisting of GeSbTe+Al or GeSbTeSi+Al. Al was added to the representative recording film whose composition was Ge_{0.09}Si_{0.05} (Sb_{0.78}Te_{0.22})_{0.86} or Ge_{0.1}(Sb_{0.8}Te_{0.2})_{0.9} defining the composition of recording film as R₁₋ₓAlₓ where R represents GeSbTeSi or GeSbTe, respectively, we varied x from 0 to 10%.

In this example we used the substrates with the thickness of 1.1 mm. There were two kinds of tracking-guide-groove pitch, i.e., 0.31 and 0.34 μm, and the depth of the groove was about 23 nm. The materials of the protective layer, reflective layer and light-transmitting-layer were the same as in the example 1 or example 2. We evaluated jitter, recording power and cross-erase at the linear bit density of 0.13 μm/bit with the optical head whose wavelength and NA were 405 nm and 0.85, respectively. We defined the optimum recording power giving the lowest jitter value which was measured after 10 direct-overwrite on the destination track. The method for measuring cross-erase was as follows:

(1) record the 8T signal at the destination track and measure carrier level C₀ of 8T signal,

(2) overwrite random data on both adjacent tracks 10 times

(3) measure the carrier level C₁ of 8T signal at the destination track.

The cross erase was defined as C₁-C₀.

The results were summarized in Table 3 and 4. As is apparent from Table 3 and 4, the addition of Al, whose contents was about 2-8 at %, exhibited the significant improvements of recording power and cross-erase without increasing jitter. We also evaluated the archival characteristics of the recording film with Al, and found that the addition of Al gave no degradation of archival characteristics.

TABLE 3
Relation between Al contents and
read/write characteristics (GeSbTeSi + Al)

| Al | l.v. | jitter | power | groove-pitch | cross-erase |
|---|---|---|---|---|---|
| (at %) | (m/s) | (%) | (mW) | (ρm) | (dB) |
| 0 | 22 | 8 | 5.4 | 0.31 | −2 |
| 2 | 22 | 8 | 5.0 | 0.31 | −1 |
| 5 | 22 | 8 | 4.8 | 0.31 | −0.5 |
| 8 | 22 | 10 | 4.7 | 0.31 | −0.3 |
| 10 | 22 | 15 | 4.7 | 0.31 | −0.3 |
| 0 | 22 | 7.5 | 5.4 | 0.34 | 0 |
| 2 | 22 | 7.5 | 5.0 | 0.34 | 0 |
| 5 | 22 | 7.5 | 4.8 | 0.34 | 0 |
| 8 | 22 | 9.4 | 4.7 | 0.34 | 0 |
| 10 | 22 | 14 | 4.7 | 0.34 | 0 |

TABLE 4
Relation between Al contents and
read/write characteristics (GeSbTe + Al)

| Al | l.v. | jitter | power | groove-pitch | cross-erase |
|---|---|---|---|---|---|
| (at %) | (m/s) | (%) | (mW) | (μm) | (dB) |
| 0 | 15 | 9.5 | 5.6 | 0.31 | −2.1 |
| 2 | 15 | 9.4 | 5.2 | 0.31 | −0.9 |
| 5 | 15 | 9.4 | 4.9 | 0.31 | −0.4 |
| 8 | 15 | 10.5 | 4.7 | 0.31 | −0.2 |
| 10 | 15 | 15.3 | 4.7 | 0.31 | −0.2 |
| 0 | 15 | 9.2 | 5.6 | 0.34 | 0 |
| 2 | 15 | 9.2 | 5.2 | 0.34 | 0 |
| 5 | 15 | 9.2 | 4.9 | 0.34 | 0 |
| 8 | 15 | 10.2 | 4.7 | 0.34 | 0 |
| 10 | 15 | 15 | 4.7 | 0.34 | 0 |

As is evident from the above explanation, the present invention has the effects as below. It is possible to provide a recording medium which has high erasing speed (crystallization rate of the recording layer), excellent over-writing characteristics, and excellent stability of storing records (stability of an amorphous state of a recording layer). Further, according to the present invention, since rotational speed of a disk can be increased, improve transfer rate of information can be improved. Moreover, according to the present invention, the over-writing characteristics are excellent even when a beam diameter is small, thereby achieving higher recording density. Besides, according to the present invention, even in the case of a recording medium with a large disk diameter, information can be preferably rewritten by CAV without changing a recording strategy depending upon a position of the recording medium. Additionally, since information can be rewritten by CAV, it is possible to improve an effective transfer rate.

What is claimed is:

1. A phase-change recording medium for recording and reproducing information by irradiating a laser beam, comprising a reflection layer, a first protective layer, a phase-change recording layer which changes in phase between a crystallization state and an amorphous state by irradiation of a laser beam, and a second protective layer, wherein the phase-change recording layer contains a component expressed by M_{z}Si_{y}(SbₓTe₁₋ₓ)_{1-y-z} (where 0.65≦x≦0.8, 0.1≦y+z≦0.2, M represents Ge, AgIn, AuIn, or AgAuIn) as a main component.

2. The phase-change recording medium according to claim 1, wherein an absorptivity Ac of the phase-change recording layer in the crystallization state is higher than an absorptivity Aa of the phase-change recording layer in the amorphous state.

3. A phase-change recording medium for recording and reproducing information by irradiating a laser beam, comprising a reflection layer, a first protective layer, a phase-change recording layer which changes in phase between a crystallization state and an amorphous state by irradiation of a laser beam, and a second protective layer, wherein the phase-change recording layer contains a component expressed by Ge_{y}(SbₓTe₁₋ₓ)_{1-y} (where 0.02≦y≦0.15, 0.65≦x≦0.84) as a main component, and an absorptivity Ac of the phase-change recording layer in the crystallization state is higher than an absorptivity Aa of the phase-change recording layer in the amorphous state.

4. The phase change media according to claim 1 wherein the content of aluminum in the recording film is more than 2 at % and less than 8 at %.

5. The phase change media according to claim 3 wherein the content of aluminum in the recording film is more than 2 at % and less than 8 at.

6. The phase-change recording medium according to claim 1, wherein the first protective layer is 20 to 40 nm in thickness, the second protective layer is 70 to 110 nm in thickness, and a reflectivity Rc of the phase-change recording medium in the crystallization state is lower than a reflectivity Ra of the phase-change recording medium in the amorphous state.

7. The phase-change recording medium according to claim 3, wherein the first protective layer is 20 to 40 nmin thickness, the second protective layer is 70 to 110 nm in thickness, and a reflectivity Rc of the phase-change recording medium in the crystallization state is lower than a reflectivity Ra of the phase-change recording medium in the amorphous state.

8. The phase-change recording medium according to claim 1, wherein a light-absorbing layer containing at least a material selected from Ti, Ni, Cu, Au, Ag, oxide thereof, and nitride thereof as a main component between the reflection layer and the first protective layer.

9. The phase-change recording medium according to claim 3, wherein a light-absorbing layer containing at least a material selected from Ti, Ni, Cu, Au, Ag, oxide thereof, and nitride thereof as a main component between the reflection layer and the first protective layer.

10. The phase-change recording medium according to claim 8, wherein the light-absorbing layer is 3 to 20 nm in thickness.

11. The phase-change recording medium according to claim 9, wherein the light-absorbing layer is 3 to 20 nm in thickness.

12. A method for recording optical information, comprising the step of recording information by using the recording medium of claim 1, the recording medium having a constant rotational angular velocity regardless of a position along the outer circumferential direction from the center of rotation.

13. A method for recording optical information, comprising the step of recording information by using the recording medium of claim 3, the recording medium having a constant rotational angular velocity regardless of a position along the outer circumferential direction from the center of rotation.

14. A method for recording optical information, comprising the step of recording information by using the recording medium of claim 1 and an identical recording strategy, the recording medium having a constant rotational angular velocity regardless of a position along the outer circumferential direction from the center of rotation.

15. A method for recording optical information, comprising the step of recording information by using the recording medium of claim 3 and an identical recording strategy, the recording medium having a constant rotational angular velocity regardless of a position along the outer circumferential direction from the center of rotation.

16. A method for recording optical information, comprising the steps of:
changing a cooling pulse width of a recording pulse end part according to a position along the outer circumferential direction from the center of rotation; and
recording information by using the recording medium of claim 1, the recording medium having a constant rotational angular velocity.

17. A method for recording optical information, comprising the steps of:
changing a cooling pulse width of a recording pulse end part according to a position along the outer circumferential direction from the center of rotation; and
recording information by using the recording medium of claim 3, the recording medium having a constant rotational angular velocity.

18. A recorder comprising the recording medium of claim 1.

19. A recorder comprising the recording medium of claim 3.
